(19) United States
(12) Patent Application Publication
(10) Pub. No.: US 2024/0090665 A1
(43) Pub. Date: Mar. 21, 2024

(54) LIGATURE RESISTANT CABINET

(71) Applicant: Acorn Engineering Company, City Of Industry, CA (US)

(72) Inventor: Darryl M. Boeltl, Whittier, CA (US)

(21) Appl. No.: 17/948,526

(22) Filed: Sep. 20, 2022

(51) Int. Cl. A47B 96/00

(52) U.S. Cl. CPC A47B 96/00

(57) ABSTRACT

A ligature resistant cabinet having a housing and an attached door. The housing includes a rear wall and a plurality of side walls, the side walls including a top wall, a bottom wall, a left side wall and a right side wall. The plurality of side walls cooperate with the rear wall to define an interior chamber. The housing further having a front side, opposite the rear wall, with portions defining a front opening for access into the interior chamber. Also, the top wall slopes downward from the rear wall to the front side. The door is mounted to the housing and is moveable between a closed position covering the front opening and an open position. At least one of the housing and the door define a beveled face. The beveled face extends circumferentially about the front opening.

### BACKGROUND

### 1. Field of the Invention

The present invention generally relates to cabinets, and more specifically to a ligature resistant cabinet.

### 2. Description of Related Art

Devices and furniture designed to be ligature resistant are a generally a requirement in institutions where the occupants may be at risk. Such institutions include, without limitation, correctional facilities, detention centers, hospitals and mental health residential facilities. Ligature resistant items are designed without places where a ligature, such as a cord, rope, bedsheets or other fabric/material, can be tied or looped over to create a sustainable attachment point that may result in self-harm or loss of life to the occupant.

### SUMMARY

In satisfying the above need, as well as overcoming the enumerated drawbacks and other limitations of the related art, the present invention provides In one aspect the present invention provides a ligature resistant cabinet for mounting to a wall or other vertical support surface.

In another aspect the present invention provides a ligature resistant cabinet having a housing and an attached door. The housing includes a rear wall and a plurality of side walls, the side walls including a top wall, a bottom wall, a left side wall and a right side wall. The plurality of side walls cooperate with the rear wall to define an interior chamber. The housing further having a front side, opposite the rear wall, with portions defining a front opening for access into the interior chamber. Also, the top wall slopes downward from the rear wall to the front side. The door is mounted to the housing and is moveable between a closed position covering the front opening and an open position. At least one of the housing and the door define a beveled face. The beveled face extends circumferentially about the front opening in the closed position.

In another aspect, the beveled face is defined by the housing.

In a further aspect, the beveled face includes a first face and a second face, the first face extending in a first plane generally parallel to the rear wall, the second face defining an acute angle relative to the first plane.

In an additional aspect, along at least a first portion of the second face the acute angle is in the range of 30 to 60 degrees, inclusive.

In yet another aspect, along at least a second portion of the second face the acute angle is in the range of 60 to 89 degrees, inclusive.

In still a further aspect, the beveled face includes a third face, the third face extending in a second plane generally parallel to the rear wall.

In an additional aspect, the first plane is spaced a first distance from the rear wall and the second plane is spaced a second distance from the rear wall, the first distance being different from the second distance.

In still another aspect, the first distance is less than the second distance.

In yet a further aspect, the second face extends between the first face and the second face.

In an additional aspect, the second face extends from the first face in a direction away from rear wall.

In another aspect, the second face extends from the first face in a direction toward the rear wall.

In a further aspect, the portions defining the front opening are portions of the first face.

In an additional aspect, the door is mounted to the first face.

In still another aspect, the door is mounted to the first face by a hinge.

In yet a further aspect, the beveled face is defined by the door.

In an additional aspect, the beveled face defines a perimeter of the door.

In yet another aspect, the perimeter circumscribed the font opening when the door is in the closed position.

In still a further aspect, the door includes a center panel defining a plane extending parallel to the rear wall in the closed position.

In an additional aspect, the beveled face extends from the center panel in a direction toward the rear wall.

In another aspect, the beveled face define an acute angle relative to the plane, the acute angle being in the range of 30 to 60 degrees.

In a further aspect, each of the housing and door defines a beveled face.

In an additional aspect, the top wall includes a first downward sloping portion defining a first acute angle relative to rear wall and a second downward sloping portion defining a second acute angle relative to rear wall, the second acute angle being different from the first acute angle.

In still another aspect, the first acute angle is greater than the second acute angel.

In yet a further aspect, the first downward sloping portion extends from the rear wall to the second downward sloping portion.

In an additional aspect, the rear wall is configured for mounting in surface-to-surface engagement with a vertically extending support surface.

In yet another aspect, the left and right side walls are configured for mounting to a vertically extending support surface.

In still a further aspect, at least a portion of the left and right side walls are configured for surface-to-surface engagement with a vertically extending support surface.

In an additional aspect, the plurality of side walls include a necked down portion defining a portion of the housing having a reduced length and width between the plurality of side walls.

Further objects, features and advantages of this invention will become readily apparent to persons skilled in the art after review of the following description, including the claims, and with reference to the drawings that are appended to and form a part of this specification.

### BRIEF DESCRIPTION OF THE DRAWINGS

FIG. 1 is a perspective view of a cabinet incorporating the principles of the present invention.

FIG. 2 is a front view of the cabinet seen in FIG. 1.

FIG. 3 is a lengthwise cross sectional view of the cabinet seen in FIG. 1, generally taken along line 3-3.

FIG. 4 is a transverse cross sectional view of the cabinet seen in FIG. 1, generally taken along line 4-4.

FIG. 5 is a perspective view of an alternative cabinet incorporating the principles of the present invention.

FIG. 6 is a transverse cross sectional view of the cabinet seen in FIG. 5, generally taken along line 6-6.

### DETAILED DESCRIPTION

As used in the description that follows, directional terms such as “upper” and “lower” are used with reference to the orientation of the elements as presented in the figures. Accordingly, “upper” indicates a direction toward the top of the figure and “lower” indicates a direction toward the bottom of the figure. The terms “left” and “right” are similarly interpreted. The terms “inward” or “inner” and “outward” or “outer” indicate a direction that is generally toward or away from a central axis of the referred to part, whether or not such an axis is designated in the figures. An axial surface is therefore one that faces in the axial direction. In other words, an axial surface faces in a direction along the central axis. A radial surface therefore faces radially, generally away from or toward the central axis. It will be understood, however, that in actual implementation, the directional references used herein may not necessarily correspond with the installation and orientation of the corresponding components or device.

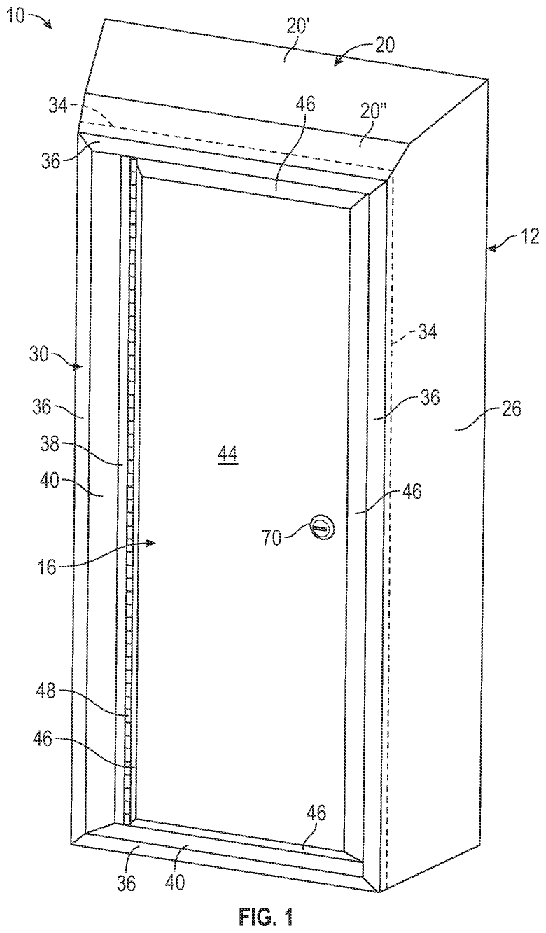

Referring now to the drawings, a cabinet embodying the principles of the present invention is generally illustrated in FIG. 1 and designated at 10. The cabinet 10 includes as its principal components a housing 12 defining a front opening 14 over which is mounted a door 16.

The housing 12 includes a rear wall 18 with four side walls extending outward therefrom and defined as a top wall 20, bottom wall 22, left side wall 24 and right side wall 26 (collectively referred to herein as “the side walls”), which are secured to one another and cooperate to define an interior chamber 28 of the cabinet 10.

As illustrated, the rear wall 18 is rectangular in shape, however, other shapes may be utilized. Additionally, the rear wall 18 is configured for mounting to a wall or other support structure and, as such, may include apertures for receipt of conventional fasteners, such screws, toggle bolts, etc.

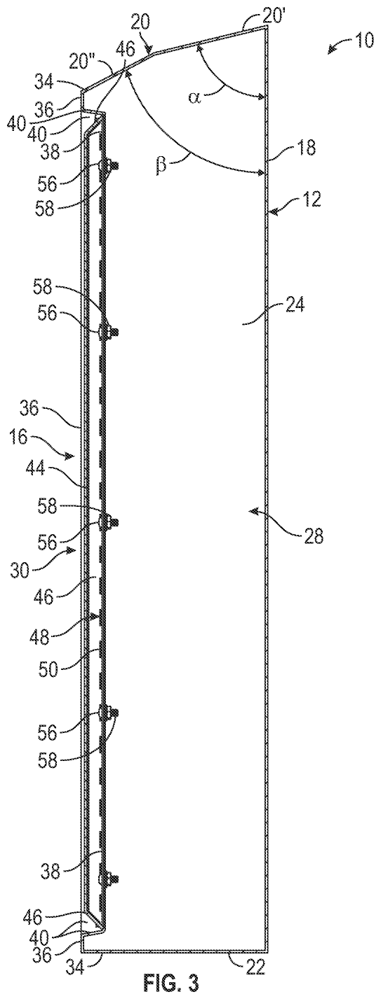

The top wall 20, bottom wall 22, left side wall 24 and right side wall 26 all extend from the rear wall 18 in a direction away from the wall. However, the present cabinet 10 is a ligature resistant cabinet 10 and therefore incorporates ligature resistant features. In order to be considered ligature resistant, the cabinet 10 must be constructed without places where a ligature, such as a cord, rope, bedsheets or other fabric/material, can be tied or looped over to create a sustainable attachment point that may result in loss of life or self-harm. For this reason, some of the side walls of the cabinet 10 do not extend perpendicularly from the rear wall 18. In particular, as seen in FIGS. 1-3, the top wall 20 slopes downward from the wall and extends from rear wall 18 at an angle (α), measured on the interior of the cabinet 10, that is less than 90 degrees, and preferably not more than 85 degrees and more preferably not more than 75 degrees. In other words, the top wall 20 slopes downward at an angle of greater than 5 degrees, and preferably greater than 15 degrees, from a horizontal plane extending perpendicular to the wall. In an additional preferred construction, the top wall 20 exhibits a multi-angle construction where a portion 20′ of the top wall 20 initially extends at a first angle (α), for about half the width of the top wall 20, and thereafter a second portion 20″ extends at a second angle (β), providing the top wall 20 with a steeper exterior surface adjacent to the front of the cabinet 20. In one exemplary embodiment, the first angle is not more than 75 degrees and the second angle is not more than 66 degrees, measured as originally noted above.

While the left and right side walls 24, 26 may extend perpendicularly to the rear wall 18 and still provide the cabinet 10 with ligature resistance, it is preferred that the left and right walls 24, 26 also extend from the rear wall 18 at an angle (γ), measured on the interior of the cabinet 10, that is less than 90 degrees, preferably not more than 85 degrees and more preferably not more than 75 degrees. Stated a different way, the left and right side walls 24, 26 angle inward and toward one another at an angle of greater than 5 degrees, and preferably greater than 15 degrees, from vertical planes extending perpendicular to the wall. The provided construction therefor generally gives the cabinet 10 a trapezoidal pyramid construction over three of the side walls.

The bottom wall 22, not being a surface about which a ligature can be looped or fastened, may extend perpendicularly, at an angle of 90 degrees, from the rear wall 18, and does so in the illustrated embodiment so as to provide a flat bottom within the interior chamber 28 and upon which items, such as a fire extinguisher, may be readily placed and stored.

Preferably the rear and side walls 18, 20, 22, 24, 26 are formed from a rigid metal material, such as steel, including stainless steel, and are stamped or cut from a single piece of metal and thereafter bent, seam welded and ground flush at all seams between the rear and side walls 18, 20, 22, 24, 26 and between the side walls 20, 22, 24, 26 themselves. Alternatively, one or more of the rear wall and side walls 18, 20, 22, 24, 26 may be formed individually and then seam welded and ground flush as mentioned above. Additionally, if color is desired for the cabinet 10, the housing 12 may be powder coated.

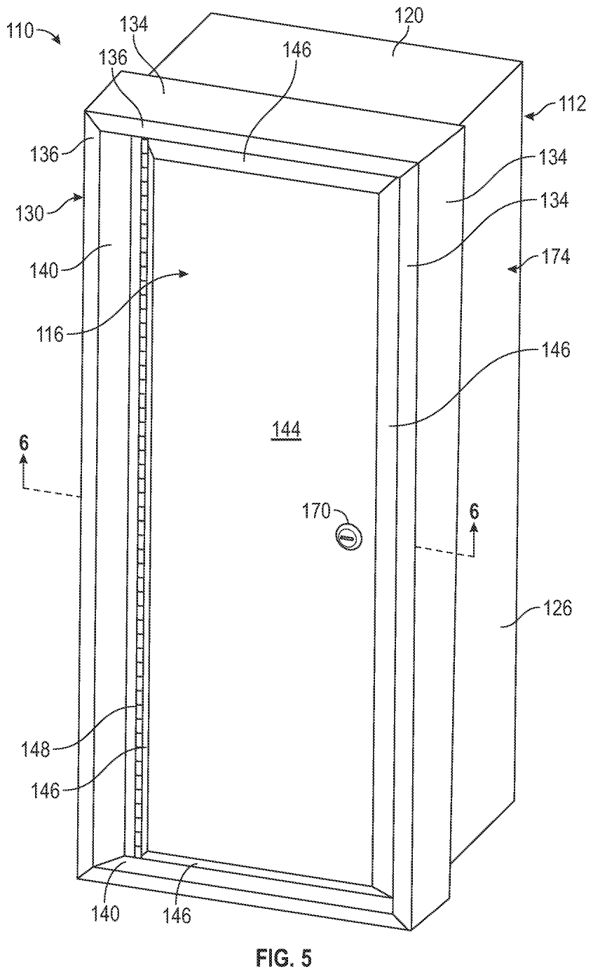

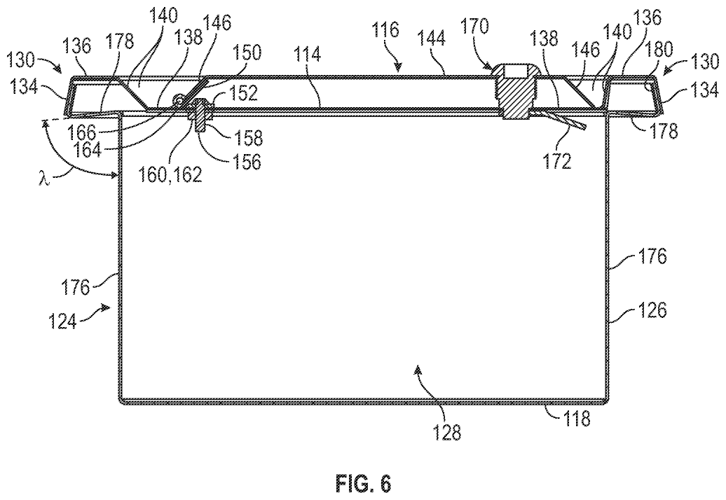

The housing 12 further includes a frame or bezel 30 extending around a perimeter defined by the front ends of the side walls 20, 22, 24, 26 (the ends/edges opposite from the ends/edges attached to the rear wall 18. Portions of the bezel 30 may be unitarily formed (one piece) with the respectively adjacent side wall 20, 22, 24, 26 (as seen in FIGS. 1-4) or the bezel 30 may be formed as a separate structure and integrally attached to the side walls 20, 22, 24, 26 about the front perimeter thereof, via seam welding and flush grinding (as seen in FIGS. 5 and 6 and further discussed below).

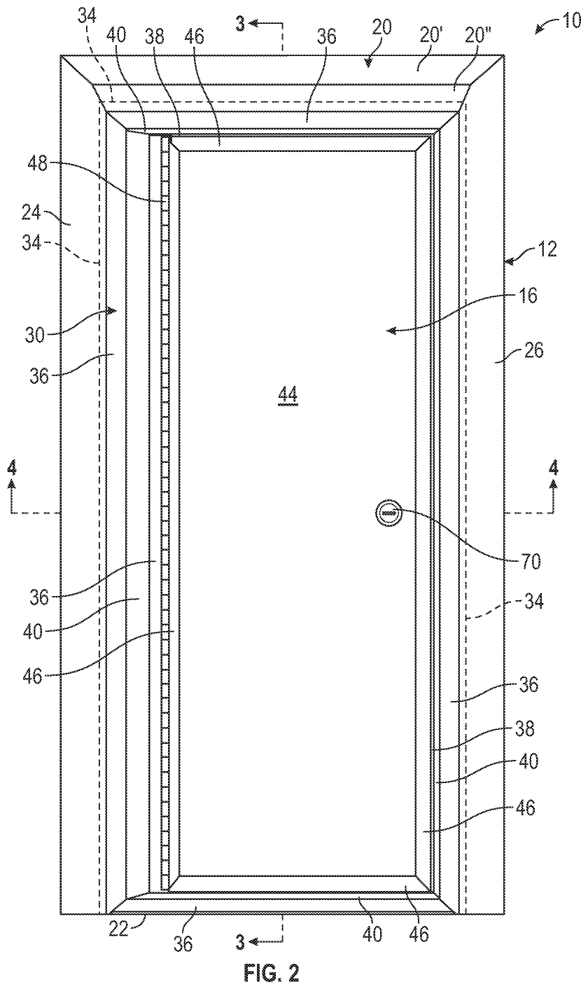

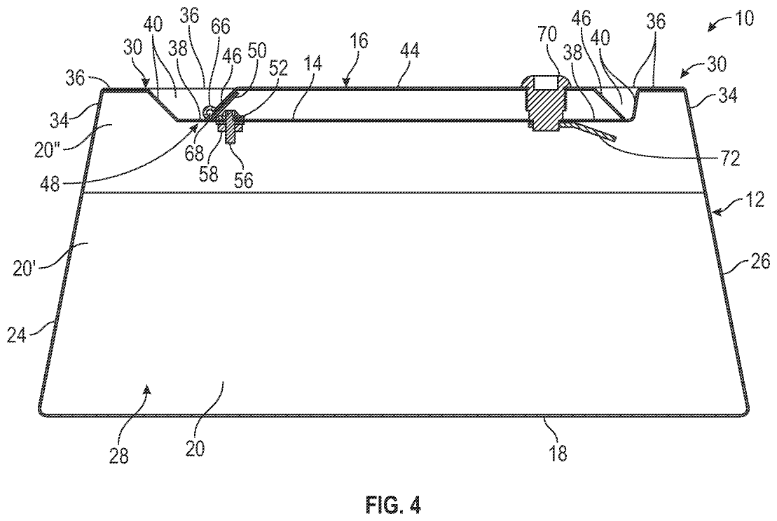

Again referring to FIG. 4, when viewed in transverse cross section, the bezel 30 includes a plurality of faces or surfaces that encircle and define the front opening 14 into the cabinet 10. The bezel 30 includes an outboard face 34 (which is a portion of the side walls 20, 22, 24, 26 (designated in phantom in FIG. 2) if the bezel 30 is unitarily formed with the side walls 20, 22, 24, 26, an outer front face 36, and inner front face 38 and a beveled face 40 extending between the outer and inner front faces 36, 38. The outboard face 34 has an exterior surface facing in a direction, and at an angle, corresponding with the respective side wall 20, 22, 24, 26 that is adjacent thereto. As used in this sense, adjacent is defined in a direction extending rearward toward the wall or rear wall. Thus, the outboard face 34 may be oriented at an angle that is less than 90 degrees, preferably not more than 85 degrees and more preferably not more than 75 degrees relative to the rear wall 18.

Continuing to refer to the transverse cross section of FIG. 4, the outer front face 36 extends inward from the outboard face 34, generally parallel to the rear wall 18. The inner front face 38 also extends inwardly, but from the beveled face 40, generally parallel to the rear wall 18. The inner front face 38 is thus located radially inward from the outer front face 36. The beveled face 40 connects the outer and inner front faces 36, 38 and extends inwardly from the outer front face 38 at a non-perpendicular angle toward the inner front face 38 and the rear wall 18. Preferably, the beveled face 40 is provided at an angle in the range of 45 degrees to 85 degrees, measured from the plane defined by the outer front face 36. As noted above, a section of the bezel 30 is provided adjacent to each of the side walls 20, 22, 24, 26 and the bezel 20 circumscribes the front opening 14 of the housing 12, which is specifically defined by the innermost extent of the inner front face 38. It should therefore be noted that the angularity of the beveled face 40 need not be identical for each section of the bezel 30. For example, for the section of the bezel 30 adjacent to the left side wall 24, the beveled face 40 may be provided at an angle of 50 degrees; for the section of the bezel 30 adjacent to the right side wall 26, the beveled face 40 may be provided at an angle of 85 degrees; for the section of the bezel 30 adjacent to the top wall 20, the beveled face 40 may be provided at an angle of 85 degrees; and for the section of the bezel 30 adjacent to the bottom wall 22, the beveled face 40 may be provided at an angle of 85 degrees.

Mounted to the bezel 30, and covering the front opening 14 when in a closed position, is the door 16. More specifically, the door is mounted to the inner front face 38 of the section of the bezel 30 adjacent to the left side wall 24 to provide a door 16 that opens to the left. Alternatively, the door may be mounted to the inner front face 38 of the section of the bezel 30 adjacent to the right side wall 26 to provide a door 16 that opens to the right.

The door 16 itself generally rectangular and includes a center panel 44 with beveled faces 46 about its perimeter. The beveled faces 46 are preferably equally angled on all four sides, in a direction toward the rear wall 18, and are configured such that the plane defined by the exterior surface of the center panel 44 is generally flush with the outer front faces 36 of the bezel 30. Preferably, the each side defined by the beveled faces 46 is provided at an acute angle (δ) in the range of 45 to 85 degrees, measured from a plane defined by the center panel 44. As seen in the figures, the beveled faces 46 are provided at an angle (δ) of about 50 degrees. To mount the door 16 to the housing 12, a hinge 48 is provided and secured between the door 16 and the inner front face 38 that is located adjacent to the left side wall 24. Preferably the hinge 48 is a piano-style hinge, as shown, having one leaf 50 secured to the inner front face 38 and a second leaf 52 secured to the inner surface 54 of the corresponding beveled face 46 of the door 16. The leaf 52 secured to the beveled face 46 of the door 16 is preferable spot welded at spaced locations to the inner surface 54 of the beveled face 46. The leaf 50 secured to the inner front face 38 may be spot welded to the inner front face 38 or secured by spaced apart common fasteners, such as a threaded bolt 56 and lock nut 58 extended through apertures 60, 62 in the leaf 50 and inner front face 38, respectively. The interlaced knuckles 64, 66 of the hinge 48 receive one or more pins 68 therethrough so as to retain the two halves of the hinge 48 together. Finally, the length of the hinge 48 is selected so that its ends terminate immediately adjacent to beveled faces 40 of the upper and lower sections of the bezel 30.

On the opposing side of the door 16, the door 16 is provided with a lock assembly 70. The lock assembly 70 is preferably a keyed cylinder lock assembly including a tab 72 that is rotatable between positions where it is engaged behind the inner front face 38 adjacent to the right sidewall 26 (as seen in FIG. 4), and a position where it is not engaged with the inner front face 38 and moveable through the front opening 14. Cylinder lock assemblies are well known and, accordingly, further detailed discussion thereof is not provided herein.

Having the at least one of the beveled faces 40, 46, and preferably both beveled faces 40, 46, the area about the door 16, the cabinet 10 is provided with an additional ligature resistant feature. The bevel faces 40, 46 operate to define a gap sufficiently wide to prevent insertion or wedging of a pencil, spoon handle or other rod/bar-like member in the space between the door 16 and a portion of the housing 12 about the door so as to form an anchor point for a ligature. With the wide gap provided via the present construction, the rod/bar-like member is inhibited from being wedged and retained to form an anchor point.

As described above, the cabinet 10 is surface mounted to the wall. In an alternative embodiment, the cabinet 110 is mounted in a recess formed to the wall. As seen in FIGS. 5 and 6, the construction of the recessed mounted cabinet 110 is substantially the same as the construction described above. Accordingly, like reference numerals are used in connection with like components of the recess mounted cabinet 110, except with a 100 series designation. Attention is therefore directed to the above discussion for common components and the following discussion will focus on differences between the constructions.

The construction seen in FIG. 5 differs from the previously discussed construction in that the cabinet 110 protrudes a shorter distance from the surface of the wall than the cabinet 10. This is the result of the rear wall 118 and a portion of the side walls 118, 120, 122, 124, 126 being extended through a recess/opening in the wall. In short, the side walls 120, 122, 124, 126 are provided with a necked down or stepped decrease portion 174 that allows a portion of the cabinet 110 to extend into the recess and another portion to extend beyond the wall. Where the cabinet 110 extends beyond the wall, the construction of the cabinet 110 is as previously described.

The necked down portions 174 of the side walls 120, 122, 124, 126 reduce the width between opposing side walls 120, 122 and 124, 126 and reduce the width and length of the rear wall 118 as would be absent the necked down portions 174. Extending from the rear wall 118, a recess portion 176 of the side walls 120, 122, 124, 126 first extends generally perpendicularly to the rear wall 118. The distance between the recess portions 176 of the left and right side walls 124, 126 should be sufficient to allow this portion of the housing 112 to extend between studs (not shown) in the wall. The length that the recessed portions 176 of the side walls 120, 122, 124, 126 extend from the rear wall 118 is dependent on design intent for the portion of the cabinet 110 intended to be visible on the exterior side of the wall. For example, one half of the depth of the interior chamber 128 of the cabinet 110 may be located within the recess of the wall and one half of the depth may be located exteriorly of the wall. Alternatively, a majority of the depth of the interior chamber 128 may be located within the recess of the wall and relatively small portion of the depth may be located exteriorly of the wall. The relative depths are thus a matter of design choice for the appearance of the portion of the cabinet 110 that is located outside of the wall.

Accordingly, after extending the desired length from the rear wall 118, the recess portions 176 of the side walls 120, 122, 124, 126 each extend laterally outward and define a step portion 178. The step portions 178 of the side walls 120, 122, 124, 126 are to be positioned generally against the wall when the cabinet 110 is positioned in the recess of the wall. The step portions 178 may define an angle (X) relative to the recessed portions 176 that is 90 degrees or preferably slightly less than 90 degrees and about 85 degrees. The length of the step portions 178 is dependent on the desired appearance for the overall width and height exposed portion of the cabinet 110.

At the outboard extent of the step portions 178, the side walls 120, 122, 124, 126 terminate in returnly bent flange portions 180 that are secured to the outboard faces 134 of the bezel 130. Preferably, the flange portions 180 are secured on an inward side of the outboard faces 134 by filet, seam or spot welding. Being secured to the outboard faces 134, the angle that the flange portion 180 is returnly bent relative to the step portion 178 is chosen so that the flange portion 180 is aligned with the outboard face 134 and substantially in surface to surface contact therewith. Preferably, the end of the outboard face 134 will then be immediately adjacent to the surface of the wall.

When mounting the cabinet 110 to the wall, the cabinet 110 may be mounted with common fasteners through either the side walls 120, 122, 124, 126 or the rear wall 118, depending the configuration of the wall.

The above description is meant to be illustrative of at least one preferred implementation incorporating the principles of the invention. One skilled in the art will really appreciate that the invention is susceptible to modification, variation and change without departing from the true spirit and fair scope of the invention, as defined in the claims that follow. The terminology used herein is therefore intended to be understood in the nature of words of description and not words of limitation.

I/We claim:

1. A ligature resistant cabinet for mounting to a wall, the cabinet comprising;
a housing, the housing including a rear wall and a plurality of side walls, the side walls including a top wall, a bottom wall, a left side wall and a right side wall, the plurality of side walls cooperating with the rear wall to define an interior chamber of the housing, the housing further having a front side opposite the rear wall, the front side including portions defining a front opening providing an opening into the interior chamber, the top wall slopes downward from the rear wall to the front side;
a door, the door being mounted to the housing and being moveable between an open position and a closed position, the closed position covering the front opening; and
at least one of the housing and the door defining a beveled face, the beveled face extending circumferentially about the front opening in the closed position.

2. The ligature resistant cabinet according to claim 1, wherein the beveled face is defined by the housing.

3. The ligature resistant cabinet according to claim 2, wherein the beveled face includes a first face and a second face, the first face extending in a first plane generally parallel to the rear wall, the second face defining an acute angle relative to the first plane.

4. The ligature resistant cabinet according to claim 3, wherein along at least a first portion of the second face the acute angle is in the range of 30 to 60 degrees, inclusive.

5. The ligature resistant cabinet according to claim 4, wherein along at least a second portion of the second face the acute angle is in the range of 60 to 89 degrees, inclusive.

6. The ligature resistant cabinet according to claim 3, wherein the beveled face includes a third face, the third face extending in a second plane generally parallel to the rear wall.

7. The ligature resistant cabinet according to claim 6, wherein the first plane is spaced a first distance from the rear wall and the second plane is spaced a second distance from the rear wall, the first distance being different from the second distance.

8. The ligature resistant cabinet according to claim 7, wherein the first distance is less than the second distance.

9. The ligature resistant cabinet according to claim 6, wherein the second face extends between the first face and the second face.

10. The ligature resistant cabinet according to claim 3, wherein the second face extends from the first face in a direction away from rear wall.

11. The ligature resistant cabinet according to claim 3, wherein the second face extends from the first face in a direction toward the rear wall.

12. The ligature resistant cabinet according to claim 3, wherein the portions defining the front opening are portions of the first face.

13. The ligature resistant cabinet according to claim 12, wherein the door is mounted to the first face.

14. The ligature resistant cabinet according to claim 13, wherein the door is mounted to the first face by a hinge.

15. The ligature resistant cabinet according to claim 1, wherein the beveled face is defined by the door.

16. The ligature resistant cabinet according to claim 15, wherein the beveled face defines a perimeter of the door.

17. The ligature resistant cabinet according to claim 16, wherein the perimeter circumscribed the font opening when the door is in the closed position.

18. The ligature resistant cabinet according to claim 16, wherein the door includes a center panel defining a plane extending parallel to the rear wall in the closed position.

19. The ligature resistant cabinet according to claim 18, wherein the beveled face extends from the center panel in a direction toward the rear wall.

20. The ligature resistant cabinet according to claim 19, wherein the beveled face define an acute angle relative to the plane, the acute angle being in the range of 30 to 60 degrees.

21. The ligature resistant cabinet according to claim 1, wherein each of the housing and door defines a beveled face.

22. The ligature resistant cabinet according to claim 1, wherein the top wall includes a first downward sloping portion defining a first acute angle relative to rear wall and a second downward sloping portion defining a second acute angle relative to rear wall, the second acute angle being different from the first acute angle.

23. The ligature resistant cabinet according to claim 22, wherein the first acute angle is greater than the second acute angel.

24. The ligature resistant cabinet according to claim 22, wherein the first downward sloping portion extends from the rear wall to the second downward sloping portion.

25. The ligature resistant cabinet according to claim 1, wherein the rear wall is configured for mounting in surface-to-surface engagement with a vertically extending support surface.

26. The ligature resistant cabinet according to claim 1, wherein the left and right side walls are configured for mounting to a vertically extending support surface.

27. The ligature resistant cabinet according to claim 1, wherein at least a portion of the left and right side walls are configured for surface-to-surface engagement with a vertically extending support surface.

28. The ligature resistant cabinet according to claim 1, wherein the plurality of side walls include a necked down portion defining a portion of the housing having a reduced length and width between the plurality of side walls.
